(19) United States
(12) Patent Application Publication
(10) Pub. No.: US 2020/0269525 A1
(43) Pub. Date: Aug. 27, 2020

(54) HYBRID BAMBOO CARBON FIBER MATERIAL AND ASSOCIATED METHODS

(71) Applicant: Resource Fiber LLC, Homewood, AL (US)

(72) Inventor: Leland Slaven, JR., Land O Lakes, FL (US)

(21) Appl. No.: 16/799,717

(22) Filed: Feb. 24, 2020

Related U.S. Application Data
(60) Provisional application No. 62/809,453, filed on Feb. 22, 2019.

(51) Int. Cl. B29C 70/18; B29C 70/08; B29C 70/46; D06M 15/263; D06M 15/227

(52) U.S. Cl. CPC B29C 70/18; B29C 70/083; D06M 2101/40; D06M 15/263; D06M 15/227; B29C 70/465

(57) ABSTRACT

The technology in accordance with embodiments of the present technology provides a hybrid fiber reinforced material comprising a plurality of conditioned bamboo fibers, a plurality of carbon fibers arranged with the plurality of conditioned bamboo fibers, and a resin matrix encapsulating the arrangement of conditioned bamboo fibers and carbon fibers. The encapsulated arrangement can be formed when heated a first time into a first shape and cooled a first time. The encapsulated arrangement can be reformable into a second shape different than the first shape when heated a second time and cooled a second time.

### CROSS REFERENCE TO RELATED APPLICATION

This application claims priority to and the benefit of U.S. Provisional Patent Application No. 62/809,453, titled HYBRID BAMBOO CARBON FIBER MATERIAL AND ASSOCIATED METHODS, filed Feb. 22, 2019, and which is incorporated herein in its entirety by reference thereto.

### TECHNICAL FIELD

The technology of the present patent application is directed to fiber reinforced material, and more particularly to materials reinforced with multiple fibers, including bamboo fibers, and associated methods of manufacturing and/or using the fiber-reinforced materials.

### BACKGROUND OF THE INVENTION

U.S. Pat. No. 9,566,769 titled Composite Sheet Material and Method for Manufacturing the Same discloses a composite sheet material that includes a substrate, a matrix, and a cover sheet, wherein the matrix is attached to the substrate and has a support component with a melting point less than the melting point of a thermoplastic component. The cover sheet imparts one or more surface characteristics to the composite sheet material during thermo-pressure formation of the composite sheet material. Accordingly, sheets of film and fiber layers are layered in a sequence and pressed to form a sheet. Other conventional technologies provide fiber-reinforced materials, such as aligned and/or woven carbon fiber reinforced materials, that are configured to provide sheets with high directional strength. Conventional materials are typically expensive and labor intensive to manufacture, resulting in an expensive end product. There is a need for an improved material and associated methods.

### BRIEF DESCRIPTION OF THE DRAWINGS

FIG. 1 is a schematic view of an assembly for forming a hybrid bamboo carbon fiber material in sheet form in accordance with an embodiment of the present technology.

FIG. 2 is a schematic view of an assembly for forming a hybrid bamboo carbon fiber material in pellet form.

FIG. 3 is a partial schematic isometric view of a sheet of hybrid bamboo carbon fiber material in accordance with an embodiment of the present technology.

FIG. 4 is a partial schematic isometric view of a sheet of hybrid bamboo carbon fiber material in accordance with another embodiment of the present technology.

### DESCRIPTION

The present technology overcomes drawbacks experienced in the prior art and provides other benefits. Aspects of the present technology provide a hybrid bamboo (or other vegetable cane fiber) and carbon fiber reinforced materials that include a combination of conditioned bamboo fibers and carbon fibers with a resin binder configured in a manner to manufacture the hybrid bio-carbon fiber material in sheet, plate, or pellet form capable of being reshaped or molded into a part or parts having the light weight and stiffness benefits of carbon fiber, but also having superior energy/impact absorption while also being less brittle. The hybrid bio-carbon fiber material also provides improved energy absorption as compared to conventional carbon fiber composite materials, such that the hybrid bio-carbon fiber material provides substantively improved vibration dampening and noise attenuation. Because of the bamboo fibers' natural growth and sequestration of carbon from the atmosphere, the material of the present technology provides a more environmentally friendly material that allows for energy efficient manufacturing and processing into its conditioned state for combination with the carbon fiber and bonding resin. The present technology includes combining the raw materials and extruding/molding or casting of the composite material into sheets, plates, layers, shapes and selected forms, which may be re-formable and curable into a final shape or configuration. While embodiments of the present technology are disclosed in connection with the use of conditioned bamboo fibers, the present technology is also applicable to use with other conditioned vegetable cane fibers in a hybrid bio-carbon fiber material.

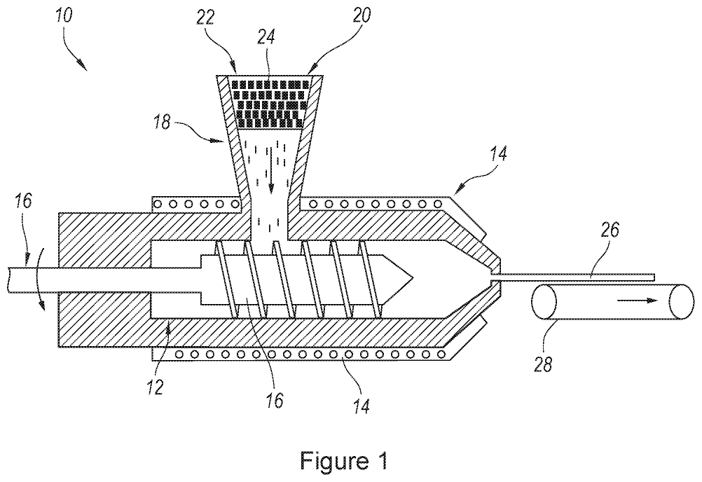

FIG. 1 is a schematic view of an assembly 10 for forming a hybrid bamboo carbon fiber material in sheet form in accordance with an embodiment of the present technology. The assembly 10 has a barrel 12 heated by heaters 14 and that contains a rotating screw 16 (e.g., an auger or other advancing mechanism) that communicates with a hopper 18 that contains a mixture of conditioned bamboo fibers 20, carbon fibers 22, and resin binder 24. The mixture of the conditioned bamboo fibers 20, carbon fibers 22 and the resin binder 24 enters the barrel 12 and is heated into a flowable blend of material that is advanced through the barrel 12 via the rotating screw 16. The blended flowable material is extruded or otherwise formed into one consolidated hybrid sheet 26 of the bamboo fibers 20 and the carbon fibers 22 encapsulated or otherwise contained within a matrix formed by the resin binder 24. The hybrid sheet 26 exits the barrel 12 and is received on a cooling roll 28 that facilitates cooling of the hybrid sheet 26. Other cooling features or techniques can be used to cool the hybrid sheet 29. The hybrid sheet 26 can be initially formed to a selected size and/or shape. For example, the hybrid sheet 26 can be cast flat for ease of shipping to a manufacturing and assembly facility to be reformed by heating a second time and pressing or vacuum molding hybrid sheet 26 into usable parts or components with a contoured shape different than the initial planar shape of the hybrid sheet 26.

The bamboo 20 can be conditioned using processing and conditioning techniques and systems disclosed in U.S. patent application Ser. No. 14/673,659, titled APPARATUS AND METHOD FOR PROCESSING BAMBOO OR VEGETABLE CANE, filed Mar. 30, 2015, and U.S. patent application Ser. No. 15/647,061, titled APPARATUS AND METHOD FOR CONDITIONING BAMBOO OR VEGETABLE CANE FIBER, filed Jul. 11, 2017, each of which are incorporated herein in their entireties by reference thereto. The resulting conditioned bamboo is configured so that the bamboo does not require any additional surface treatments, such as chemical treatment, for proper adherence with the resign binder. Accordingly, use of the conditioned bamboo results decreases the number of process steps and associated costs by eliminating a need for surface treatments prior to being combined with the binder resin.

In some embodiments, the carbon fibers 22 can be conventional chopped or pre-impregnated carbon fibers, and the resin 24 can include polypropylene, vinyl Ester or other binder depending on specific properties needed for the end product. The carbon fibers 22 used in embodiments of the present technology can be recycled carbon fibers or virgin (original, non-recycled) carbon fibers. The carbon fibers 22 and/or the conditioned bamboo fibers 20 can be chopped or otherwise sized for a selected hybrid material output. For example, the length of the fibers 20 and/or 22 can be in the range of approximately 0.25″-12.0″, although the fibers can have other lengths in other embodiments. The conditioned bamboo fibers 20 can have approximately the same lengths as the carbon fibers 22. In other embodiments, the conditioned bamboo fibers 20 can have lengths different than the carbon fibers 22 (i.e., shorter or longer than the carbon fibers 22).

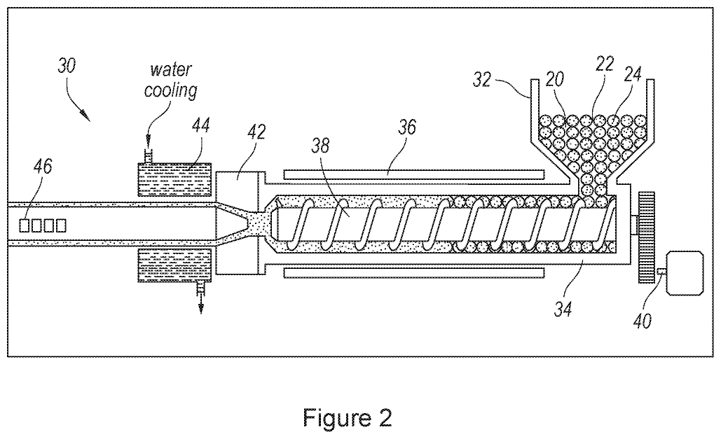

FIG. 2 is a schematic view of an assembly 30 for forming a hybrid bamboo carbon fiber material in pellet form in accordance with an embodiment of the present technology. The assembly 30 has a hopper 32 that consolidates the conditioned bamboo fibers 20, carbon fibers 22, and resin binder 24 and feed them into a melting chamber 34 connected to one or more heaters 36. The conditioned bamboo fibers 20, carbon fibers 22 and the resin binder 24 enter the heated barrel 12 from the hopper 32, are heated into a flowable blend of material that is advanced through the chamber 34 via a rotating screw 38 (e.g., an auger or other advancing mechanism), which can be driven by a motor assembly 40. The blended flowable material is advanced through a selected die 42 configured to form pellets 46 of the mixture of the conditioned bamboo fibers 20 and carbon fibers 22 within the matrix formed by the resin binder 24. As the material exits the pelletizing die 42, the material is cooled via a cooling system, such as a water-cooled cooler 44 positioned downstream of the die 42. The assembly 30 is configured to produce pellets 46 of processable size to be used for subsequent injection molding, extruding, pultruding, or other processing or reforming into selected usable parts or components.

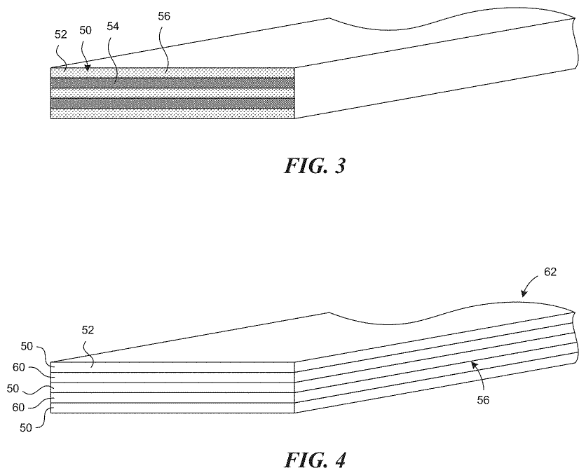

In another embodiment illustrated in FIG. 3, conditioned bamboo mats 50 formed by the substantially parallel conditioned bamboo fibers 52 can be combined with one or more layers of carbon fibers 54 and encapsulated or impregnated with a matrix formed by the resin material 56 to form a sheet of hybrid bamboo carbon fiber material 58. In one embodiment, the conditioned bamboo fibers 52 in substantially parallel orientations can be combined with the substantially parallel carbon fibers 54 in a planar sheet configuration, and the planar, parallel mixture of fibers are encapsulated or impregnated with the resin 56 to form a hybrid bio-carbon sheet 58 that may be re-formable and curable into a subsequent final shape or configuration. In another embodiment, the sheet 58 can have the long, parallel carbon and bamboo fibers arranged in generally random orders. Alternatively, some or all parts of the hybrid sheet 58 can have selected concentrations of the conditioned bamboo fibers 52 or the carbon fibers 54 at selected portions of the sheet.

In another embodiment illustrated in FIG. 4, a sheet of hybrid conditioned bamboo carbon fiber material can have one or more layers formed by one or more mats 50 of conditioned bamboo fibers 52 laminated with one or more sheets 60 of carbon fiber materials and encapsulated or impregnated with a selected resin material 56 to form a laminated bio-carbon fiber assembly 62. This laminated bio-carbon fiber assembly 62 may be subsequently re-formed and cured into a final format. The laminated assembly 62 can have the carbon fibers and bamboo fibers in substantially parallel orientations. Alternatively, the carbon fibers and bamboo fibers can be oriented at selected angles relative to each other, such as perpendicular orientations, or other selected angles. Layers of the conditioned bamboo fibers 52 can be arranged in the manner described in U.S. Pat. No. 9,937,685 titled Industrial Products Engineered From Processed Bamboo or Vegetable Cane, which is incorporated herein in its entirety by reference. One or more layers of carbon fibers 60 may be positioned between or adjacent to the layers of conditioned bamboo fibers 52.

In the embodiments of the hybrid bamboo carbon fiber material discussed above, the resin matrix can make up approximately 60% or more by weight of the material, and the conditioned bamboo fibers and the carbon fibers combined can be up to approximately 40% by weight of the material. In such an arrangement, the conditioned bamboo fibers can comprise up to 50% total fibers, such that each of the conditioned bamboo fibers and the carbon fibers comprise up to about 20% by weight of the material. Other embodiments can include different ratios of the conditioned bamboo fibers to the carbon fibers depending upon the desired properties (i.e., weight, flexibility, strength, etc.) of the resulting hybrid bamboo carbon fiber material. Carbon fiber, like bamboo, is low in density (1.8 g/cc) but possesses seven times higher modulus than bamboo. The combination of conditioned bamboo in conjunction with the textile grade carbon fiber (TCF), as an example, from the Carbon Fiber Technology Facility at the Oak Ridge National Laboratory, in accordance with one or more embodiments of the present technology provides several opportunities and benefits, such as (a) optimization of both stiffness and impact energy absorption with light weighting benefits; (b) enhanced vibration and noise dampening; and (c) low cost solution where the low cost of bamboo overcomes the limitations of an expensive ‘all carbon’ solution for lightweight vehicle components such as underbody, skin layers, decking, front and rear end inserts, side panels, etc. The present disclosure's hybrid bamboo/carbon technology also applies to use for, as an example, planking or other components for truck and trailer-based transportation. For example, the hybrid bamboo/carbon technology can be incorporated into the type of composite decking disclosed in U.S. patent application Ser. No. 16/003,020, titled Bamboo and/or Vegetable Cane Composite Decking and Process, filed Jan. 7, 2018, which is incorporated herein in its entirety by reference thereto.

Certain bamboo species, when conditioned, engineered and manufactured into products correctly, can replicate the characteristics of old growth wood. This results in higher quality products, greater durability and stability, and a longer product life than many wood products currently on the market. The TCF has commercial low-cost feasibility at less than $5 per pound and hence provides a significant aspect of this technology.

The hybrid bamboo-carbon fiber reinforced composite material in accordance with the present technology can be configured with exceptional mechanical properties while the conditioned bamboo fibers replaces about 50% of carbon fiber. The hybrid products' distinct and unique mechanical properties are superior to conventional carbon fiber alone. For example, the hybrid bamboo-carbon fiber material of the present technology can be initially formed into a selected shape or arrangement, but the material can be re-formable into a subsequent shape or configuration. Further, using bamboo in the present technology can effectively offset some of the limitations of carbon fiber, such as (a) the high cost of carbon fiber (bamboo is about ⅕th the cost of carbon fiber); (b) the high-use of energy in supply chain and manufacturing (230 MJ/kg to produce carbon fiber, while only 9.55 MJ/kg to produce bamboo fibers); (c) carbon fiber is brittle and has low impact resistance, while bamboo has high energy absorption capacity; (d) underutilized capacity at existing carbon fiber facilities; (e) bamboo offers green solutions; and (f) the high cost of recycling carbon fiber, while recycling and biodegradability of bamboo fibers is a distinct advantage. The hybrid bamboo carbon fiber material of the present technology is also more recyclable and compostable as compared to conventional carbon fiber composite materials.

The hybrid bamboo/carbon material of the present technology can also be formed into intermediate configurations in the form of, for example, wet laid mats, tapes, stitch bonded and pellets. For example, the hybrid bamboo/carbon material can be formed into pellets by chopping or otherwise providing the bamboo fibers and the carbon fibers in similar lengths, mixing the fiber together for a substantially random mixture of the fibers, about 50% of which are the bamboo fibers and about 50% of which are the carbon fibers. In other embodiments, other amounts of bamboo and carbon fiber may be used. For example, the bamboo can be in the range of about 40%-60% of the fibers, and the carbon fibers can be in the range of about 60%-40% of the fibers. The fibers are also blended with a selected resin, such as polypropylene, vinyl Ester or other binder, and the resin/fiber mixtures are formed into pellets via a pelletizer or other suitable device. In other embodiments, the hybrid bamboo/carbon material can be formed into sheet-like intermediate forms by mixing the bamboo fibers and the carbon fibers of similar or different lengths in a substantially random orientation and encapsulated or impregnated with the selected resin (e.g., polypropylene, vinyl Ester or other binder) to form the intermediate sheet-like material. These intermediate configurations can then be converted to selected final part designs through selected molding processes or techniques including, but not limited to, extrusion-compression, injection molding, twin screw compounding, compression stamping, roll forming, pultrusion and resin transfer molding are representative examples of the types of processes used to convert the intermediates to shapes/parts.

I claim:

1. A hybrid fiber reinforced material, comprising:
a plurality of conditioned bamboo fibers;
a plurality of carbon fibers arranged with the plurality of conditioned bamboo fibers; and
a resin matrix encapsulating the arrangement of conditioned bamboo fibers and carbon fibers.

2. The material of claim 1 wherein the conditioned bamboo fibers and the carbon fibers each comprise up to approximately 20% by weight of the material.

3. The material of claim 1 wherein the conditioned bamboo fibers are arranged in a random pattern relative to each other.

4. The material of claim 1 wherein the conditioned bamboo fibers are arranged in a parallel orientation relative to each other.

5. The material of claim 1 wherein the resin encapsulated conditioned bamboo fibers and carbon fibers are formed as pellets.

6. The material of claim 1 wherein the resin encapsulated conditioned bamboo fibers and carbon fibers are formed as extruded sheets.

7. The material of claim 1 wherein the resin encapsulated conditioned bamboo fibers and carbon fibers are formed as sheets.

8. The material of claim 1 wherein the conditioned bamboo fibers comprise a matt of interconnected bamboo fibers

9. The material of claim 1 wherein the conditioned bamboo fibers have a length in the range of 0.25″-12.0″

10. The material of claim 1 wherein the conditioned bamboo fibers and the carbon fibers have substantially the same length.

11. The material of claim 1 wherein the conditioned bamboo fibers and the carbon fibers have different lengths.

12. The material of claim 1 wherein the resin matrix is a poly propylene or vinyl Ester resin.

13. The material of claim 1 wherein the resin encapsulated conditioned bamboo fibers and carbon fibers are formed in a first shape and are configured to be heated and remolded into a second shape different than the first shape.

14. A reformable hybrid fiber reinforced material comprising:
conditioned bamboo fibers arranged with a plurality of carbon fibers; and
a resin matrix encapsulating the arrangement of conditioned bamboo fibers and carbon fibers,
wherein the encapsulated arrangement is formed when heated a first time into a first shape and cooled a first time; and
wherein the encapsulated arrangement is reformable into a second shape different than the first shape when heated a second time and cooled a second time.

15. The material of claim 14 wherein the conditioned bamboo fibers and the carbon fibers each comprise up to approximately 20% by weight of the material.

16. The material of claim 14 wherein the conditioned bamboo fibers are arranged in a random pattern relative to each other.

17. The material of claim 14 wherein the resin encapsulated conditioned bamboo fibers and carbon fibers in the first shape are in sheet format.

18. The material of claim 14 wherein the conditioned bamboo fibers comprise a matt of interconnected bamboo fibers

19. The material of claim 14 wherein the conditioned bamboo fibers have a length in the range of 0.25″-12.0″

20. The material of claim 1 wherein the conditioned bamboo fibers and the carbon fibers have substantially the same length.
